(19) United States
(12) Patent Application Publication
(10) Pub. No.: US 2016/0087887 A1
(43) Pub. Date: Mar. 24, 2016

(54) ROUTING FABRIC

(71) Applicant: Hei Tao Fung, Fremont, CA (US)

(72) Inventor: Hei Tao Fung, Fremont, CA (US)

(21) Appl. No.: 14/493,331

(22) Filed: Sep. 22, 2014

(51) Int. Cl. H04L 12/741; H04L 12/841; H04L 12/935

(52) U.S. Cl. CPC H04L 45/74; H04L 49/3009; H04L 47/286; H04W 84/10

(57) ABSTRACT

A system and method of using a switch fabric of commodity Ethernet switches to produce a scalable router is disclosed. A special-format Media Access Control (MAC) address is assigned to each switch. The assigned MAC address of a switch comprises some bits that can identify the topological location of the switch. The switch fabric intercepts and responds to address resolution requests from hosts with assigned MAC addresses of switches. A packet received from a host is forwarded according to those bits in the destination MAC address of the packet. It further uses some bits in the MAC address to achieve network virtualization.

### FIELD OF THE INVENTION

This application related to computer networking and more particularly to creating a switch fabric that behaves as a router.

### BACKGROUND

Most high-capacity routers today are chassis-based systems. A typical chassis-based router has a number of slots where router modules can be plugged into, and the router modules are interconnected via a backplane or mid-plane fabric of the chassis. The scalability of the system is therefore limited by the number of slots provisioned and the capacity of the backplane or mid-plane fabric.

Software defined networking (SDN) is an approach to building a computer network that separates and abstracts elements of the networking systems. It has become more important with the emergence of compute virtualization where virtual machines (VMs) may be dynamically spawned or moved, to which the network needs to quickly respond. Also driven by popularity of compute virtualization, network virtualization addresses the need of separating the IP address space of tenants in a multi-tenant data center network.

SDN decouples the system that makes decisions about where traffic is sent (i.e., the control plane) from the system that forwards traffic to the selected destination (i.e., the data plane). OpenFlow is a communications protocol that enables a controller (i.e., the control plane) to access and configure the switches (i.e., the data plane).

Recently, there have been commodity OpenFlow Ethernet switches in the market. Those switches are relatively low-cost, but they also have severe limitations in terms of the number of classification entries and the variety of classification keys. Supposedly, an OpenFlow device offers the ability of controlling the traffic by flows. The severe limitations of those switches greatly discount the ability because the number of flows that can be configured on those switches is relatively small, e.g. in thousands.

Those limitations are inherent in the hardware designed and have nothing to do with OpenFlow, and OpenFlow is still good for enabling the control plane to configure the data plane. However, the assumption that the control plan can configure many (e.g. millions) of flows via OpenFlow or even any other communications protocol functionally similar to OpenFlow to the data plane may not hold. In this invention, we disclose a system and method of using commodity switches to produce a scalable router, taking into considerations the limitations of the commodity switches.

### SUMMARY OF THE INVENTION

An object of the invention is to produce a scalable router using a switch fabric of commodity Ethernet switches. The router is capable of supporting network virtualization.

The system comprises a plurality of switches. The switches can be connected in any topology. Hosts can be connected to the switch fabric on any switch on any port. The hosts can be physical machines as well as virtual machines and even networking devices. A host in our context is just a target recipient of an Internet Protocol (IP) packet. That is, a host has an IP address that matches the destination IP address of an IP packet.

The system also comprises a controller. The controller conveys forwarding rules onto the switches. The switches process packets by the forwarding rules.

In our invention, packets are routed according to destination Media Access Control (MAC) addresses of the packets, and those MAC addresses are crafted and assigned to the switches.

In a traditional learning switch network, a MAC address uniquely identifies a network interface of a host. A MAC address consists of a three-byte Organizationally Unique Identifier (OUI) and a three-byte number assigned by the vendor who owns a specific OUI number and manufactures the network interface card (NIC). MAC addresses of hosts are learned on switch ports, and packets are forwarded by destination MAC addresses of the packets without interpreting meanings of the MAC addresses.

In our invention, each switch is assigned a MAC address that has meaning. The MAC address comprises a set of bits identifying the location of the switch in the switch fabric. When forwarding a packet, the set of bits is used to find an egress port along a path in the switch fabric that leads to the switch. Also, the MAC address may further comprise a set of bits identifying the virtualized IP address space that belongs to a host.

In our invention, hosts attached to the system require no change to its networking software stack. Specifically, a host sends Address Resolution Protocol (ARP) requests for target hosts, including computers and routers, and expects ARP replies that provide MAC addresses of the target hosts. The controller or a switch in our switch fabric intercepts the ARP requests and responds with ARP replies that provide MAC addresses of the switches that can reach the target hosts. Similarly, for an IPv6 host, a host sends Neighbor Solicitation messages for target hosts, including computers and routers, and expects Neighbor Advertisement messages that provide MAC addresses of the target hosts. The controller or a switch in our switch fabric intercepts the Neighbor Solicitation messages and responds with Neighbor Advertisement messages that provide MAC addresses of the switches that can reach the target hosts.

In a traditional IP router network, an IP packet is forwarded by destination IP address of the IP packet from one router to the next router towards the final router that has the target host attached to it. From one router to the next router, the destination MAC address of the IP packet is replaced by the MAC address of the next router and the source MAC address of the IP packet by the MAC address of the current router. At the final router, the destination MAC address of the IP packet is replaced by the MAC address of the target host and the source MAC address of the IP packet by the MAC address of the final router.

In our invention, when an IP packet is targeting a host on the same IP subnet, the destination and source MAC addresses of the IP packet are not changed from one switch to the next switch. At the final switch, the destination MAC address of the IP packet is replaced by the MAC address of the target host. The source MAC address of the IP packet is replaced by the MAC address of the final switch or by a traditional OUI-type MAC address assigned to the switch fabric.

In our invention, when an IP packet is targeting a host on a different IP subnet, the destination and source MAC addresses of the IP packet may, under some conditions, be changed from one switch to the next switch in the path leading to the host. For example, the destination MAC address of the IP packet is replaced by the MAC address of a switch that contains more forwarding rules for the IP packet.

In a traditional IP router network that supports IP address space virtualization, an IP packet is forwarded by the destination IP address of the IP packet and a Virtual Routing and Forwarding (VRF) identifier which is derived from the ingress port or the Virtual Local Area Network (VLAN) identifier of the IP packet.

In our invention, when supporting IP address space virtualization, an IP packet is forwarded by the destination IP address of the IP packet and a Virtual Routing and Forwarding (VRF) identifier which is derived from the destination MAC address of the IP packet when the destination MAC address of the IP packet matches a MAC address assigned to the switch. Alternatively, the VRF identifier can also be derived from the VLAN identifier of the IP packet.

Our invention has taken into account the limited number of forwarding rules supported on commodity switches. The fact that a MAC address assigned to a switch in the switch fabric embeds the typological location of the switch enables a dramatic reduction in the number of forwarding rules required to forward packets among hosts attached to the switch fabric. That is especially true when, firstly, aggregatable values of the location-related set of bits in MAC address are assigned to a number of topologically adjacent switches, and when, secondly, Ternary Content Addressable Memory (TCAM) is used to implement the forwarding rules.

Our invention has also taken into account the security concern of IP address space virtualization. Embedding a value in MAC address that identifies the virtualized IP address space that belongs to a host helps filtering out packets from the host that are forged to affect hosts operating in another virtualized IP address space. The filtering can be based on the value in MAC address.

### BRIEF DESCRIPTION OF THE DRAWINGS/FIGURES

The present disclosure will be understood more fully from the detailed description that follows and from the accompanying drawings, which however, should not be taken to limit the disclosed subject matter to the specific embodiments shown, but are for explanation and understanding only.

FIG. 1 illustrates an example of a switch fabric.

FIG. 2a illustrates the format of a traditional MAC address.

FIG. 2b illustrates an embodiment of special-format MAC address.

FIG. 2c is an example of a special-format MAC address.

FIG. 3 illustrates an embodiment of event handling on a controller.

FIG. 4 illustrates an embodiment of event handling on a switch.

FIG. 5 illustrates an embodiment of packet handling rules on a switch.

FIG. 6 illustrates the effects on a packet destined to a host on the same subnet.

FIG. 7 illustrates the effects on a packet destined to a host on a different subnet.

### DETAILED DESCRIPTION OF THE INVENTION

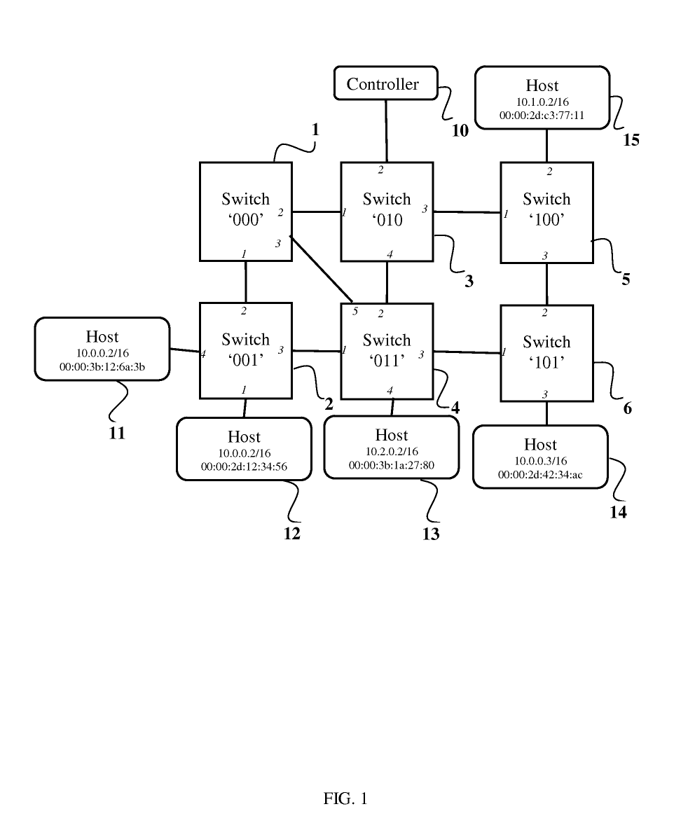

FIG. 1 illustrates an example of a switch fabric in this invention. The system comprises a plurality of switches and a controller. Like a typical SDN controller, the controller establishes a control session to each switch in the switch fabric. We consider that switches having control sessions to the controller being part of the switch fabric. In FIG. 1, all switches are part of the switch fabric. (The current invention also works in scenarios where some non-switch-fabric switches may be attached to the switch fabric.) The control sessions can be established over the switch fabric as commonly referred to as in-band connections and also over a separate management network as commonly referred to as out-of-band connections. The controller 10 is able to selectively intercept packets received on a switch through its control session. The controller 10 is also able to inject some packets into a switch through its control session.

Having a centralized controller is a preferred embodiment of the current invention. However, the current invention does not preclude having multiple instances of controllers. They may act in active-active mode or active-standby mode. Moreover, the current invention does not preclude having no centralized controller at all but having the control plane function distributed to each switch, like in a traditional learning switch network or a traditional router network. The method of the current invention can be implemented using centralized controller or distributed controllers.

In FIG. 1, the six switches form a mesh topology and are physical switches. However, the current invention works in any network topology and even works with virtual switches running on hosts that are considered part of the switch fabric.

In the example of FIG. 1, there are five hosts. Hosts 12, 14, and 15 belong to one virtualized IP address space (VIPAS), VIPAS 0. Hosts 11 and 13 belong to another VIPAS, VIPAS 1. Though host 11 and host 12 have the same IP address 10.0.0.2, there is no conflict. Host 12 and host 14 are on the same subnet 10.0.0.0/16. Host 15 is on a different subnet, namely 10.1.0.0/16.

For sake of ease of illustration, we assume IPv4 hosts in FIG. 1. The current invention also works for IPv6 hosts. The address resolution requests and replies in IPv4 involve ARP requests and ARP replies, while the address resolution requests and replies in IPv6 involve Neighbor Solicitation messages and Neighbor Advertisement messages. Also, IPv4 involves TTL, while IPv6 involves hop limit, which is equivalent to TTL.

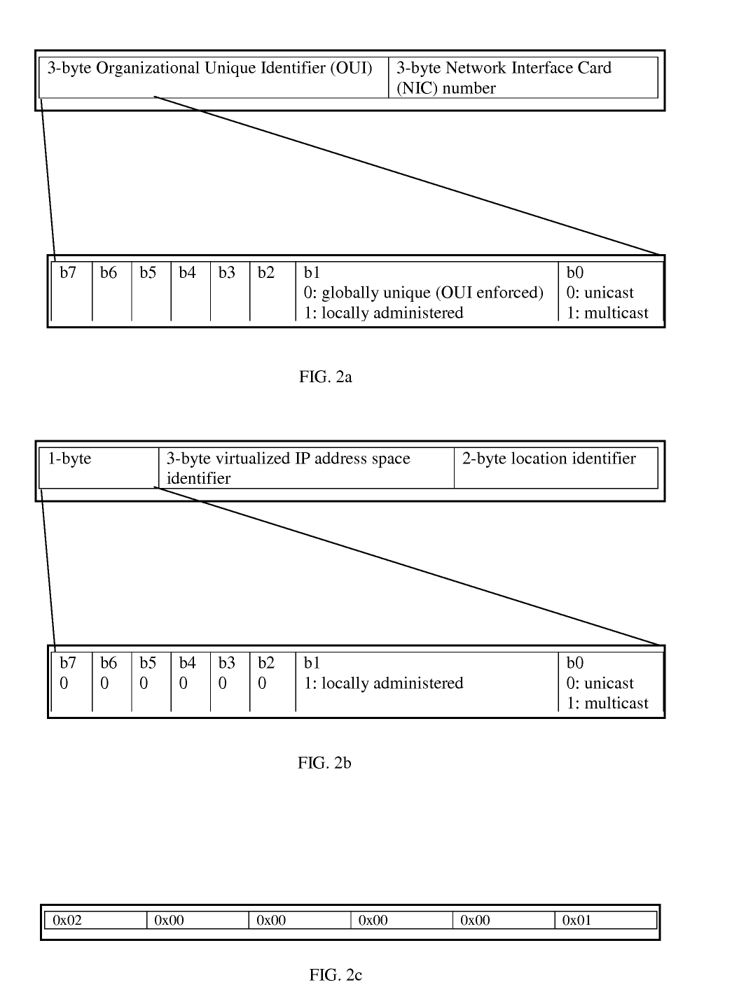

A key element of the current invention is assigning each switch a MAC address that comprises a location identifier of the switch within the switch fabric. FIG. 2a shows the format of a traditional MAC address. The first three bytes represent an OUI. A hardware vendor is assigned a unique OUI. The second three bytes uniquely identify a NIC manufactured by the hardware vendor. The six-byte MAC address should globally unique identifies a NIC. As can be seen, a traditional MAC address does not contain any location information.

FIG. 2b shows one embodiment of a MAC address format in the current invention. First of all, the locally administered bit is set to 1. That signifies a specially crafted MAC address format. A MAC address of such a special format is a logical one. It is assigned to a switch in the switch fabric. It is not assigned to a NIC. It is not assigned to a host (unless a virtual switch in the host is also considered to be part of the switch fabric). The switch is likely to have its own traditional MAC address. The forwarding decision in this invention is based on the special-format MAC address, not the traditional MAC address.

The special-format MAC address comprises a set of bits identifying the location of the switch. The bits in the set of bits do not have to be contiguous nor structured. In FIG. 2b, the set of bits has sixteen bits. In our preferred embodiment, the bits in the set of bits are contiguous and form a value. The preferred way of assigning values to the set of bits to switches is based on their topological adjacency. That facilitates bit aggregations in a masked match key when programming the forwarding rules on the switches. For example, in FIG. 1, switch 1 and switch 2 are topologically adjacent. Switch 1 is assigned binary value ‘000’, and switch 2 ‘001’ such that ‘00X’ can refer to both switches, where ‘X’ means a bit being masked out. By the same token, switch 3 and switch 4 are assigned ‘010’ and ‘011’, respectively. Switches 1, 2, 3, and 4 are topologically adjacent, and ‘0XX’ can refer to them all. Similarly, ‘10X’ can represent switch 5 and switch 6.

The assignment of special-format MAC addresses to the switches can be done programmatically. That is, through topology discovery such as using Link Layer Discovery Protocol (LLDP), the controller may then assign the MAC addresses and inform the switches. (In a distributed control function case, each switch assigns itself a MAC address consistent and non-conflicting with its adjacent neighbors.) Alternatively, the MAC address assignment can be administrator-assisted, and the controller receives the assignment as configurations and acts on it.

In FIG. 2b, the special-format MAC address further comprises a set of bits identifying the virtualized IP address space (VIPAS) that a switch may service. To support network virtualization, the IP address space of one tenant should be separated from the IP address space of another. In FIG. 1, the switch fabric is serving two tenants. The set of VIPAS identifiers is global to the switch fabric, but a switch in the switch fabric may service a subset of the VIPAS identifiers. In our preferred embodiment, a subset of VIPAS identifiers are mapped to the VRF identifiers on a switch. A commodity switch typically has a smaller number of VRF identifiers than the total number of VIPAS identifiers. Yet, a number of switches together can serve the full set of VIPAS identifiers. For example, there are VIPAS identifiers 1-20 serviced by the switch fabric. VRF identifiers 1-16 on one switch are mapped to VIPAS identifiers 1-16, and VRF identifiers 1-16 on another switch are mapped to VIPAS identifiers 5-20. In one embodiment, the special-format MAC address may comprise a VRF identifier of the switch specified by the location identifier. That is, the combination of VRF identifier and location identifier uniquely maps to a VIPAS identifier. Yet in another embodiment, the special-format MAC address comprises no bits about VIPAS. Instead, the VRF identifier of the switch specified by the location identifier is put in the VLAN identifier field of an 802.1Q tag of the packet. Our preferred embodiment, however, has the special-format MAC address comprise the VIPAS identifier. (In all three aforementioned embodiments, the switch identified by the location identifier is able to derive its locally-significant VRF identifier, either from the destination MAC address or the 802.1Q tag of the packet.) The preferred embodiment may result in the least number of security rules programmed onto the switches.

Some commodity switches may not support VRFs. Those switches can be considered as supporting only one VRF. We may still map the implicit VRF of a switch to one of the VIPAS identifiers.

The six most significant bits of the first byte in the special-format MAC address can be used as flags for semantic extensions. They can be set to zeroes for now.

FIG. 2c is an example of a MAC address assigned to switch 2 of FIG. 1. Actually, switch 2 has another MAC address, 02:00:00:01:00:01, because it serves VIPAS identifiers 0 and 1.

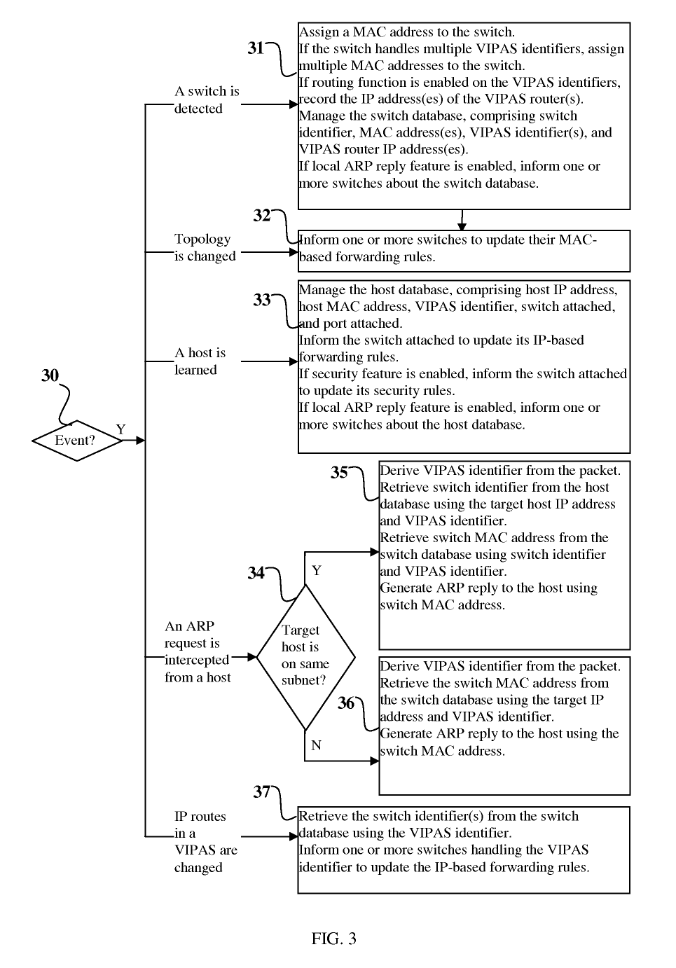

FIG. 3 illustrates how a controller may handle events. An embodiment of a controller, which is networking application software running on a host, has an event loop 30 to spawn out handlers according to the events. After an event is handled, the controller waits at the event loop 30 again. The set of events on a controller comprises switch being detected, topology being changed, host being learned, ARP request being intercepted, and IP routes being changed.

When a switch is detected, the controller assigns a special-format MAC address to the switch according to its topological location. If the switch handles multiple VIPAS identifiers, such as switch 2 in FIG. 1, multiple MAC addresses are assigned. Routing between IP subnets in a VIPAS can be supported by a host as a router. Alternatively and preferably, the switch fabric handles the routing between IP subnets in a VIPAS. Not all switches in the switch fabric need to handle the routing between IP subnets. In our preferred embodiment, one or more, but not all, switches are selected to service IP subnet routing for a particular VIPAS. To serve a full set of VIPAS, the IP subnet routing workload can be spread among all or most switches. For example, in FIG. 1, switch 3 is selected to do routing between IP subnets 10.0.0.0/16 and 10.1.0.0/16 for VIPAS identifier 0.

The hosts in a VIPAS are aware of the IP address of its VIPAS router, for example, through router discovery protocol or administrator configurations. When the switch fabric functions as that VIPAS router, the controller needs to know the IP address of that VIPAS router so that it can generate an ARP reply properly in steps 34 and 36. In step 31, the controller manages a switch database, each database entry comprising the switch identifier, the MAC address(es) of the switch, the VIPAS identifier(s) that the switch serves, and the VIPAS router IP address(es). If an ARP reply is to be generated by a switch intercepting an ARP request, then the controller needs to inform the switch about the database.

The appearance of a switch can cause topology change, so step 31 also leads to step 32. When there is a topology change, the controller may sometimes reassign some MAC addresses to some switches. The controller may sometimes inform some switches to update their MAC-based forwarding rules so as to maintain connectivity among hosts and optimal network utilization.

When a host is learned, step 33 is performed. A host may be learned by a switch receiving a packet from the host. A host may also be learned by consulting administrator configuration. The controller maintains a host database, each database entry comprising the host IP address, the host MAC address, the VIPAS identifier of the VIPAS where the host belongs, the switch identifier of the switch where the host is attached, the port identifier of the port where the host is attached. For populating a database entry, the VIPAS identifier may be derived using some default or administrator configurations, the VLAN identifier of the VLAN where the host belongs, and the switch identifier and the port identifier. It is possible that a host is connected to multiple switches or ports. The controller informs the switch where the host is attached about those host data so that the switch can update its IP-based forwarding rules and security rules. If an ARP reply is to be generated by a switch intercepting an ARP request, then the controller needs to inform the switch about the host database.

An objective of the current invention is to be compatible to existing host networking software stack. A host sends an ARP request to find out the MAC address of the target host, be it a machine or a VIPAS router. The switches in the current invention help the controller intercept ARP requests from hosts. The controller generates ARP replies in response to the intercepted ARP requests. (In another embodiment, the switch that intercepts an ARP request generates the ARP reply.) Steps 35 and 36 enable the hosts to associate the special-format MAC addresses of the switches with the target hosts. In step 35, the controller derives the VIPAS identifier from the VLAN identifier and the ingress switch port of the packet. The controller looks up the switch identifier from the host database using the target host IP address and the VIPAS identifier. Then the controller looks up the switch MAC address from the switch database using the switch identifier looked up from the host database and the VIPAS identifier. The switch MAC address should be the MAC address of the switch where the target host is attached. Then the controller generates the ARP reply using the switch MAC address.

In an alternative embodiment, the controller always replies using the switch MAC of the switch selected to do the IP subnet routing function for the VIPAS identifier. Consequently, all IP packets from the (source) host to any target host in the VIPAS are first forwarded to the switch selected to do IP subnet routing, no matter the target host is in the same subnet or in a different subnet. Such embodiment has the best security characteristics, at the expense of network utilization.

Step 36 handles the case that the switch fabric acts as the VIPAS router. In step 36, the controller derives the VIPAS identifier from the VLAN identifier and the ingress switch port of the packet. The controller obtains the switch MAC address from the switch database using the target IP address, as the VIPAS router IP address, and the VIPAS identifier. The switch MAC address should be the MAC address of the switch selected to perform the IP subnet function for the VIPAS identifier. Then, the controller generates the ARP reply using the switch MAC address.

The administrator or a routing protocol may change the IP subnet routes in a VIPAS. In step 37, the controller finds out the switch(es) selected to do the IP subnet routing function for the VIPAS from the switch database and inform the switch(es) to update its IP-based forwarding rules.

Though we suppose that the host networking software stack is not modified, the current invention works when the host networking software stack is modified in such a way that address resolution replies from the switch fabric become unnecessary. For example, in one embodiment, a host's networking software stack is configured with IP address to special-format MAC address mappings. In another embodiment, the destination MAC address of a packet from a host is overwritten with a pre-specified special-format MAC address by the host's networking software stack. In yet another embodiment, the destination MAC address of a packet is deduced from the target host IP address according to a pre-specified mapping function at the host's networking software stack.

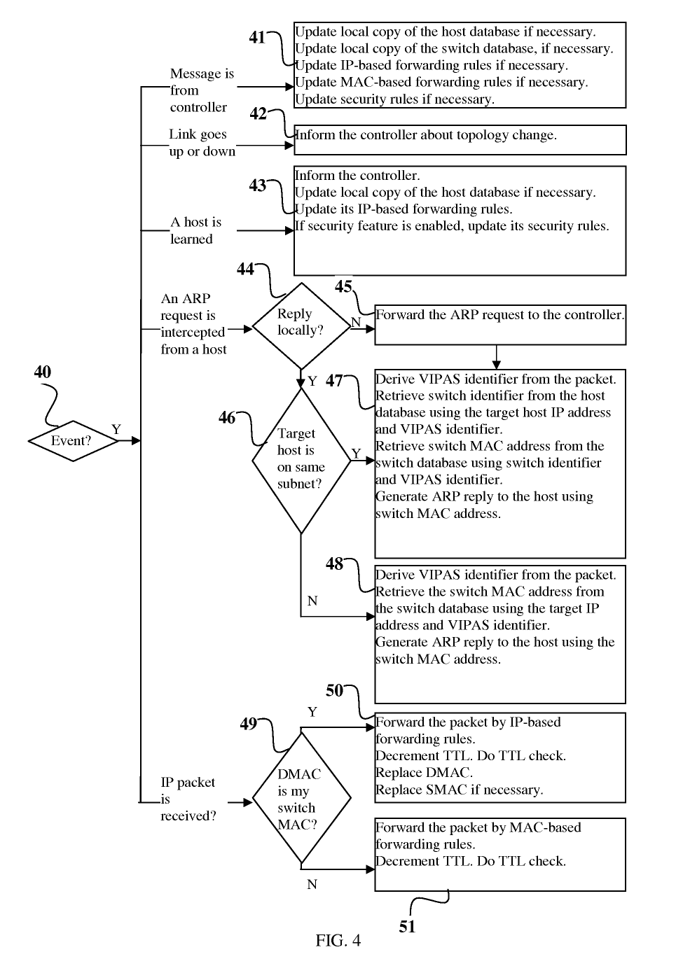

FIG. 4 shows an example how a switch in the switch fabric handles events. In the case of a physical switch, the switch has a driver handling some events and has a switch chip handling packet forwarding. (In the case of a virtual switch, i.e., software switch, the switch handles all events including packet forwarding in software.)

When a control message is received from the controller, as in step 41, the switch may update its local copy of the host database, its local copy of the switch database, its local IP-based forwarding rules, its local security rules, and its local MAC-based forwarding rules, if necessary.

When the switch detects a port going up or down or the appearance or disappearance of a neighbor, e.g., a LLDP neighbor, the switch informs the controller of the topology change in step 42. The switch may also react to the event, such as quickly shifting traffic from a failed port to an active port where the forwarding rules allow.

When the switch detects a host, as in step 43, it informs the controller. It may then react to the resulting control messages from the controller by step 41. Alternatively, it may update its local IP-based forwarding rules, local security rules, and local copy of the host database, if necessary. A switch may detect a host by intercepting packets from the host.

As another embodiment, it is not necessary for a switch to detect any host. When the switch intercepts ARP requests from a host and forwards them to the controller, the controller can detect the host.

When the switch intercepts an ARP request from a host, the switch should forward it to the controller as in step 45. To offload the controller from generating many ARP replies for switches in the switch fabric, as an alternative embodiment, it might be desirable to have the switch generate the ARP reply locally. Steps 47 and 48 generate ARP replies like steps 35 and 36.

When the switch receives an IP packet from a host, it performs step 50 if the destination MAC address (DMAC) of the IP packet matches a MAC address assigned to it; otherwise, performs step 51.

In step 50, the switch forwards the packet by its local IP-based forwarding rules. The packet may be discarded, forwarded to a target host, or forwarded to another switch. When a packet is forwarded to a target host or another switch, the switch replaces the DMAC of the packet by the MAC address obtained through the IP-based forwarding rules. It is desirable to decrement the time-to-live (TTL) value of the IP packet and discard the IP packet when the TTL value becomes zero. When the packet is forwarded to a host, the source MAC address (SMAC) of the IP packet is also replaced, by a MAC address representative of the switch fabric. That MAC address should be a traditional MAC address, i.e., with the locally-administered bit set to 0. An example is 00:00:5e:00:01:01, which is a standard virtual router redundancy protocol (VRRP) MAC address. Another example is selecting one OUI-type MAC address of a switch in the switch fabric.

In step 51, the switch forwards the IP packet by its local MAC-based forwarding rules. There is no need to modify the DMAC and SMAC of the packet. Again, it is desirable to decrement TTL value and do a TTL check.

As an alternative embodiment, steps 50 and 51 may insert, modify, or remove an 802.1Q tag in the IP packet. The 802.1Q tag contains a Class of Service (CoS) value for quality of service (QoS) operations. More importantly, the VLAN identifier field may carry a value mapped to the VIPAS identifier at the switch identified by the DMAC. If the switch receives the packet from an attached host that is untagged, the switch inserts an 802.1Q tag, whose VLAN identifier can be mapped to the VIPAS identifier. If the switch receives the packet from an attached host that is tagged, the switch modifies the 802.1Q tag if the original VLAN identifier also serves to identify the VIPAS. The VLAN identifier of the 802.1Q tag is modified to enable mapping to the VIPAS identifier at the switch referred to by the DMAC. If the switch receives the packet from an attached host that is tagged, the switch inserts an outer 802.1Q tag if the original VLAN identifier of the (now) inner 802.1Q tag actually identifies a VLAN of the attached host because the original VLAN identifier needs to be preserved. If the switch receives a double-tagged packet that is to be forwarded to an attached target host, the switch removes the outer 802.1Q tag in the packet. If the switch receives a single-tagged packet that is to be forwarded to an attached target host, the switch modifies the 802.1Q tag in the packet with a VLAN identifier that represents the VLAN of the attached target host if the attached target host expects a tagged packet. If the switch receives a single-tagged packet that is to be forwarded to an attached target host, the switch removes the 802.1Q tag in the packet if the target host expects an untagged packet.

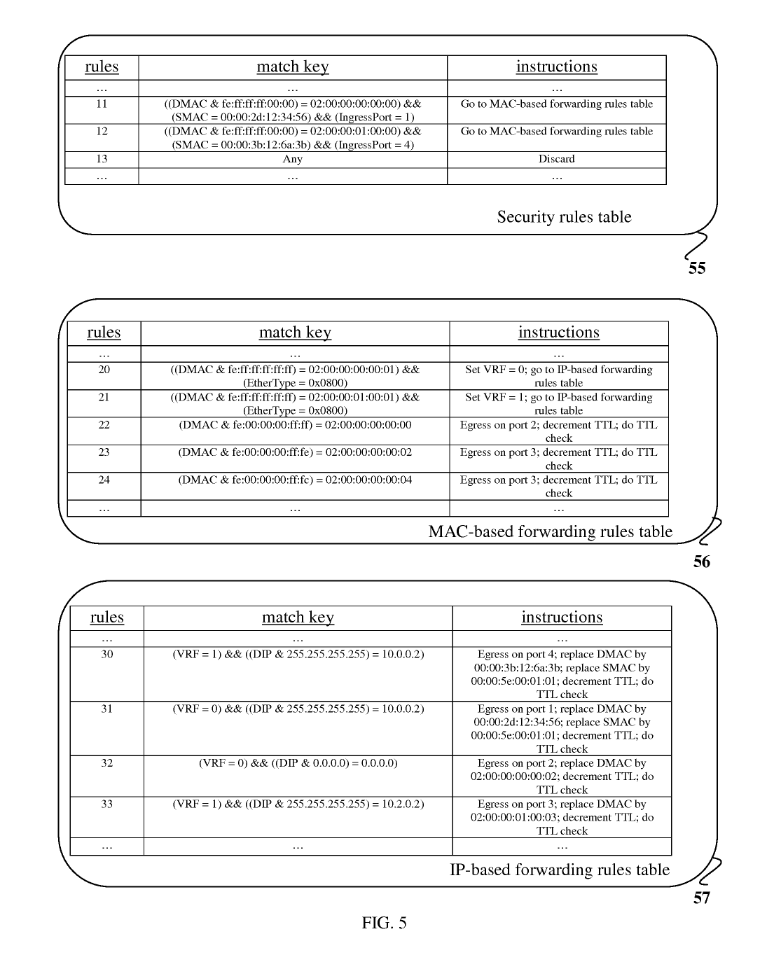

FIG. 5 illustrates an example of an embodiment of packet handling rules on a switch. The packet handling rules comprise security rules, MAC-based forwarding rules, and IP-based forwarding rules. The example is consistent with the setup in FIG. 1. Tables 55, 56, and 57 show some packet handling rules of switch 2 in FIG. 1.

Typical switches are capable of forwarding traffic by packet classification and performing instructions on a packet including sending out the packet on a specified port and inserting, modifying, or removing a header in the packet. The packet classification is usually performed via a TCAM. A TCAM consists of a number of entries, whose positions indicate the precedence of the entries. A lookup is launched on all TCAM entries. Though there may be one or more match key hits in the same lookup, the entry with higher precedence will be selected, and the resulting instructions associated with the entry will be performed on the packet. A match key can be masked. Some bits in the match key can be masked off, i.e., the values of the masked-off bits are ignored in matching. TCAM is best utilized with masked match keys. Exact match keys (unmasked match keys) can efficiently utilize non-TCAM based hash look-up. For example, table 55 can be implemented in either TCAM or hash look-up. Tables 56 and 57 can be implemented in TCAM. In tables 55, 56, and 57, the lower rule number provides a higher precedence.

The security rules in table 55 are to protect a malicious host in one VIPAS affecting hosts in another VIPAS. Rule 11 permits host 12 to only send to VIPAS 0. Rule 12 permits host 11 to only send to VIPAS 1. Rule 13 discards the packets violating the VIPAS separation.

In an alternative embodiment where VLAN identifiers are used for mapping into VIPAS identifiers, the rule 11 would become two, for example, (((DMAC & fe:00:00:00:ff:ff)=02:00:00:00:00:00:05) && (VLAN=1) && (SMAC=00:00:2d:12:34:56) && (IngressPort=1)) and (((DMAC & fe:00:00:00:ff:ff)=02:00:00:00:00:00:02) && (VLAN=7) && (SMAC=00:00:2d:12:34:56) && (IngressPort=1)), assuming VLAN identifier 1 is mapped to VIPAS 0 at switch 6, and VLAN identifier 7 is mapped to VIPAS 0 at switch 3. As can be seen, the embodiment would require more security rules to protect a VIPAS.

The MAC-based forwarding rules in table 56 use masked match keys comprising destination MAC addresses (DMAC) of packets and switch MAC addresses. ‘&’ means a bit-wise AND operation. ‘&&’ means a logical AND operation. In rule 20, the match key comprises the switch MAC address 02:00:00:00:00:01 and the DMAC of the packet. The mask fe:ff:ff:ff:ff:ff is applied to the switch MAC address and the DMAC. If the masked switch MAC address equals to the masked DMAC and the packet is an IP packet, then the resulting instructions set the VRF to 0 and further use the IP-based forwarding rules table on the packet. Because switch 2 is also assigned MAC address 02:00:00:01:00:01 as it serves VIPAS 1 in addition to VIPAS 0, a match in rule 21 results in setting VRF to 1. Therefore, rules 20 and 21 subject a packet destined to the current switch, i.e., switch 2, to using IP-based forwarding rules. Rule 22 forwards a packet destined to switch 1 out on port 2 towards switch 1. Rule 23 forwards a packet destined to switches 3 and 4 out on port 3. The mask fe:00:00:00:ff:fe helps aggregate what could be two rules into one rule, hence reducing the number of rules programmed in the table. Rule 24 forwards a packet destined to switches 5 and 6 and, if exist, switches of location identifiers ‘110’ and ‘111’ out on port 3. The mask fe:00:00:00:ff:fc helps aggregate what could two to four rules into one rule. Table 56 shows that it is advantageous to assign adjacent location identifiers to switches topologically adjacent so as to maximize the possibility of aggregating MAC-based forwarding rules into fewer rules.

The egress ports in rules 22 to 24 can be determined using a shortest path algorithm. Other path selection algorithms may be used, for example, to achieve optimal network utilization. When there is somehow a loop in the path, temporarily or unintentionally, the TTL decrementation and TTL check will help discard any looped packet. Typically, in a commodity switch, the TTL decrementation and TTL check function is only available when forwarding rules are implemented using TCAM.

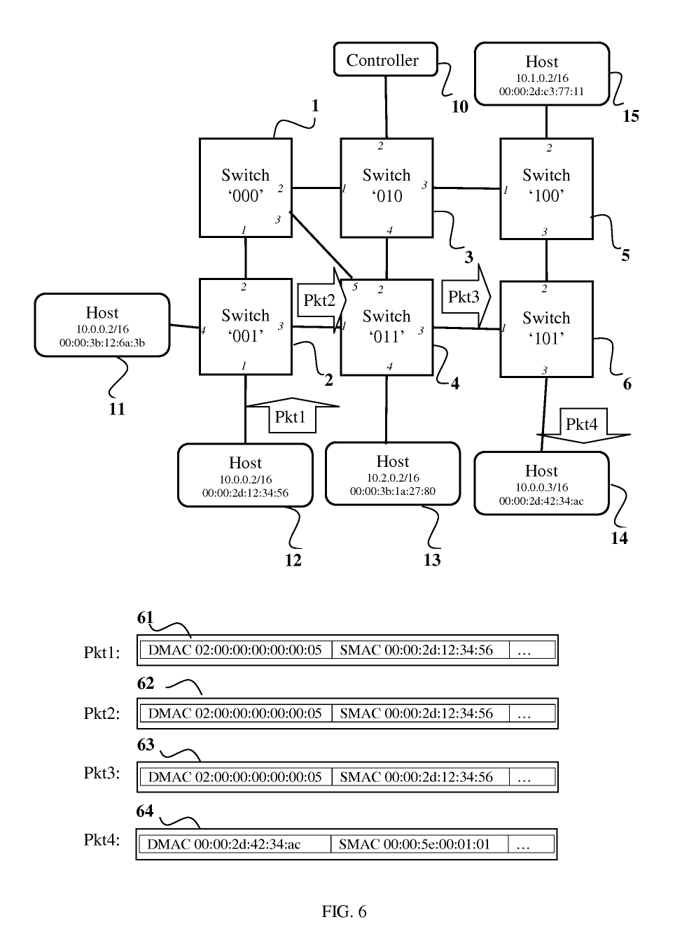

FIG. 6 shows the effects on a packet forwarded from host 12 to host 14. Host 12 has sent an ARP request packet for target host 14 IP address 10.0.0.3. The controller has sent an ARP reply packet using switch 6 MAC address 02:00:00:00:00:05 because host 14 has been learned on port 3 of switch 6. Therefore, packet 61 has DMAC 02:00:00:00:00:05. The DMAC and the SMAC of packets 62 and 63 remain the same. The TTL values of packets 62 and 63 are decremented. Switch 6 uses its IP-based forwarding rules and sets packet 64 DMAC to the host 14 MAC address 00:00:2d:42:34:ac.

The IP-based forwarding rules in table 57 use masked match keys comprising destination IP addresses (DIP) of packets, VIPAS identifiers, host IP addresses, and VIPAS IP subnets. In rule 30, the match key comprises the DIP of the packet and the VRF value derived from table 56. If the VRF value equals to 1 identifying VIPAS 1 and the DIP equals to the host 11 IP address 10.0.0.2, then the switch forwards the packet out on port 4 towards host 11, replacing the DMAC by the host 11 MAC address 00:00:3b:12:6a:3b, replacing the SMAC by the switch fabric MAC address 00:00:5e:00:01:01, decrementing TTL, and doing TTL check. Similarly, in rule 31, if the VRF value equals to 0 identifying VIPAS 0 and the DIP equals to the host 12 IP address 10.0.0.2, then the switch forwards the packet out on port 4 towards host 12, replacing the DMAC by the host 12 MAC address 00:00:2d:12:34:56, replacing the SMAC by the switch fabric MAC address 00:00:5e:00:01:01, decrementing TTL, and doing TTL check.

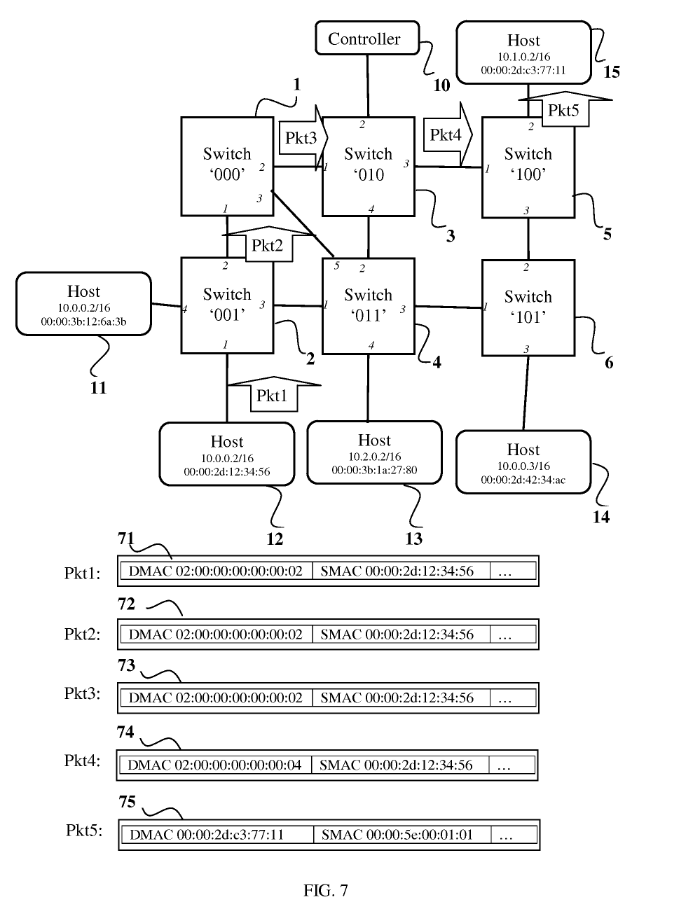

In this example, switch 3 is selected to be the VIPAS 0 IP subnet router. In rule 32 of switch 2, any packet destined to not-directly-attached hosts is forwarded towards switch 3 replacing the DMAC of the packet by switch 3 MAC address 02:00:00:00:00:02. FIG. 7 illustrates how a packet is modified forwarded from host 12 to host 15. Suppose host 12 has sent an ARP request for target host (router), say, 10.0.0.1, and the controller has replied with switch 3 MAC address 02:00:00:00:00:02 because switch 3 has been selected as the VIPAS 0 subnet IP router. Therefore, packets 71, 72, and 73 all have DMAC 02:00:00:00:00:02, their TTL values decremented along the path. At switch 3, by its local IP-based forwarding rules, it forwards the packet destined to 10.1.0.2 to switch 5. Therefore, packet 74 has DMAC 02:00:00:00:00:04. At switch 5, its local IP-based forwarding rules sets the DMAC of packet 75 to host 15 MAC address 00:00:2d:c3:77:11.

In the example of FIG. 5, switch 2 is selected to be a VIPAS 1 IP subnet router. In rule 33 of table 57, any packet destined to 10.2.0.2 is forwarded to switch 4, where host 13 is directly attached.

Switch 2 does not need to be the only VIPAS 1 IP subnet router. Now suppose there is also an IP subnet 10.3.0.0/16 in the switch fabric, and switch 1 is selected to be a second VIPAS 1 IP subnet router containing IP-based forwarding rules about hosts in 10.3.0.0/16. Then, switch 2 may have a rule matching ((VRF=1) && ((DIP & 255.255.0.0)=10.3.0.0) and directing the matched packets to switch 1 replacing DMAC by 02:00:00:01:00:00. Similarly, not all of the hosts in 10.3.0.0/16 have to be directly attached to switch 1. Switch 1 just contains IP-forwarding rules to forward the packets to the switches that have the hosts directly attached. In fact, we may even have the routes of a subnet split among multiple VIPAS IP subnet routing switches, as long as a VIPAS IP subnet routing switch is able to forward the packets that it has no specific information about to the next VIPAS IP subnet routing switch in a sequence of VIPAS IP subnet routing switches that can lead to the target hosts.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for a switch fabric, the method comprising:
assigning a Media Access Control (MAC) address to a switch, of said switch fabric, wherein said MAC address of said switch comprises a set of bits identifying a location of said switch within said switch fabric;
forwarding, at any switch other than said switch, an Internet Protocol (IP) packet destined to said MAC address of said switch according to a first match key comprising said set of bits; and
forwarding, at said switch, said IP packet destined to said MAC address of said switch according to a second match key comprising a destination IP address of said IP packet and replacing a destination MAC address of said IP packet by a MAC address retrieved by said second match key.

2. The method of claim 1, the method further comprising responding, using said MAC address of said switch, to an address resolution request for a target host when said target host of said address resolution request refers to said switch.

3. The method of claim 1, the method further comprising responding, using said MAC address of said switch, to an address resolution request for a target host when said target host of said address resolution request is attached to said switch.

4. The method of claim 1, wherein a locally-administered bit of said MAC address is set to one.

5. The method of claim 1, wherein a time-to-live (TTL) value in said IP packet is decremented by one when said IP packet is forwarded at any switch of said switch fabric.

6. The method of claim 1, wherein said MAC address comprises a second set of bits identifying a virtual IP address space, wherein said second match key further comprises an identifier of said virtual IP address space.

7. The method of claim 1, wherein a Virtual Local Area Network (VLAN) identifier of said IP packet identifies a virtual IP address space, wherein said second match key further comprises an identifier of said virtual IP address space.

8. The method of claim 1, wherein said any switch other than said switch uses Ternary Content Addressable Memory (TCAM) for matching said first match key.

9. The method of claim 1, wherein said first match key further comprises a mask, wherein one or more bits not masked out by said mask, of said set of bits, correspond to one or more MAC addresses assigned to one or more switches of said switch fabric, respectively, wherein said one or more MAC addresses comprise one or more sets of bits, respectively, identifying one or more locations of said one or more switches within said switch fabric, respectively.

10. The method of claim 9, wherein said one or more locations of said one or more switches within said switch fabric are topologically adjacent.

11. A switch fabric, comprising:
a plurality of switches; and
at least one controller,
wherein said at least one controller assigns a Media Access Control (MAC) address to a switch, of said switch fabric, wherein said MAC address of said switch comprises a set of bits identifying a location of said switch within said switch fabric;
wherein any switch other than said switch forwards an Internet Protocol (IP) packet destined to said MAC address of said switch according to a first match key comprising said set of bits; and
wherein said switch forwards said IP packet destined to said MAC address of said switch according to a second match key comprising a destination IP address of said IP packet and replaces a destination MAC address of said IP packet by a MAC address retrieved by said second match key.

12. The switch fabric of claim 11, wherein said at least one controller responds, using said MAC address of said switch, to an address resolution request for a target host when said target host of said address resolution request refers to said switch.

13. The switch fabric of claim 11, wherein one of said plurality of switches responds, using said MAC address of said switch, to an address resolution request for a target host when said target host of said address resolution request refers to said switch.

14. The switch fabric of claim 11, wherein said at least one controller responds, using said MAC address of said switch, to an address resolution request for a target host when said target host of said address resolution request is attached to said switch.

15. The switch fabric of claim 11, wherein one of said plurality of switches responds, using said MAC address of said switch, to an address resolution request for a target host when said target host of said address resolution request is attached to said switch.

16. The switch fabric of claim 11, wherein a locally-administered bit of said MAC address is set to one.

17. The switch fabric of claim 11, wherein a time-to-live (TTL) value in said IP packet is decremented by one when said IP packet is forwarded at any switch of said switch fabric.

18. The switch fabric of claim 11, wherein said MAC address comprises a second set of bits identifying a virtual IP address space, wherein said second match key further comprises an identifier of said virtual IP address space.

19. The switch fabric of claim 11, wherein a Virtual Local Area Network (VLAN) identifier of said IP packet identifies a virtual IP address space, wherein said second match key further comprises an identifier of said virtual IP address space.

20. The switch fabric of claim 11, wherein said any switch other than said switch uses Ternary Content Addressable Memory (TCAM) for matching said first match key.

21. The switch fabric of claim 11, wherein said first match key further comprises a mask, wherein one or more bits not masked out by said mask, of said set of bits, correspond to one or more MAC addresses assigned to one or more switches of said switch fabric, respectively, wherein said one or more MAC addresses comprise one or more sets of bits, respectively, identifying one or more locations of said one or more switches within said switch fabric, respectively.

22. The switch fabric of claim 21, wherein said one or more locations of said one or more switches within said switch fabric are topologically adjacent.
